(19) United States
(12) Patent Application Publication
(10) Pub. No.: US 2009/0076772 A1
(43) Pub. Date: Mar. 19, 2009

(54) Footbeds and a Method and Apparatus for Producing Such Footbeds

(75) Inventors: Glen D. Hinshaw, Scottsdale, AZ (US); Terry Dawson, Glendale, AZ (US); Simon M. Luthi, Lake Oswego, OR (US); Joseph F. McMillan, Portland, OR (US); Peter C. Rueegger, Portland, OR (US); Jae Son, Ranco Palos Verdes, CA (US); Michael Steszyn, Portland, OR (US)

Correspondence Address: GEORGE A. HERBSTER, 40 BEACH STREET, SUITE 303, MANCHESTER, MA, 01944, US

(73) Assignee: ESOLES, LLC, Scottsdale, AZ (US)

(21) Appl. No.: 11/857,186

(22) Filed: Sep. 18, 2007

(51) Int. Cl. G01B 21/20; A43B 13/38

(52) U.S. Cl. 702/167; 36/43

(57) ABSTRACT

A method and apparatus for supplying a customer with a footbed. A kiosk provides measurements of a consumer's feet with a self-guided display by using both pressure measurements and scanning of the feet. The measurement information is converted to identify which of the preselected and stocked components proximate the kiosk can be combined to provide an appropriate footbed for the consumer.

### BACKGROUND OF THE INVENTION

1. Field of the Invention

This invention generally relates to foot orthotics and more specifically to a method and apparatus for delivering to a consumer a footbed that takes into account several criteria including the plantar surface topography of each of the consumer's feet.

2. Description of Related Art

Over the years many companies have endeavored to produce a footbed that provides improved support for an individual's foot. Each method involves two basic phases, namely: a measurement phase, a production-delivery phase. The measurement phase involves a use of apparatus for obtaining meaningful measurements of the foot, particularly the topography of the plantar surface. The production-delivery phase involves the conversion of the results of the measurement phase into physical footbeds and the delivery of the finished footbeds to the consumer.

In the gold standard and dominant methodology used by medical personnel, the measurement phase requires the formation of a plaster cast and mold. A practitioner produces a plaster cast of each foot after manipulating each foot to the referenced neutral position subject to compensation for any observed anatomical deformities of that foot. The non-weight bearing condition exists when no forces are applied to the foot, as when the foot is suspended in air.

The production-delivery phase begins when the practitioner sends these casts to a laboratory. Laboratory personnel make a mold from the cast and then use personnel, information, a priori knowledge of the practitioner's procedures and other experiences to modify the molds. Then laboratory personnel use each mold to form a corresponding orthotic block which is finished at the laboratory and returned to the practitioner as an orthotic footbed.

After receipt, the practitioner dispenses the orthotic footbed to the patient. If a patient reports only little or no relief or reports discomfort, the practitioner must reevaluate the patient. If changes to the orthotic footbed are required, then either the entire process must be repeated or the orthotic footbed must be sent back to the laboratory with instructions for additional corrections.

As will be apparent, the measurement phase for this approach requires professional personnel. Production and delivery occurs generally by transporting the foot model to a production facility and returning the orthotics to the practitioner. As a result while this approach produces a very good orthotic, it is costly and involves significant delays between the measurement phase and the completion of the production-delivery phase.

U.S. Patent Application Pub. Nos. US2006/0283243 and US2006/0247892 (2006) to Peterson, and both assigned to the assignee of this invention, disclose an alternative method and apparatus for manufacturing custom footbeds corresponding in quality to those produced by the gold standard approach. During a measurement phase a scanner with an air cushion and related equipment produce a topographical map of the bottom of each foot while the foot is in a semi-weight bearing state and in the neutral position; i.e., a semi-weighted, supported, aligned position. The air cushion captures the foot in this position and measures the distances corresponding to the spacing between a reference plane and the bottom of the foot. A manufacturing facility converts these measurements into information by which a computer numerically controlled machine produces a custom orthotic insert.

This approach eliminates the need for producing and transporting a foot model to a manufacturing site. However, the measurement phase still requires professional personnel to position the individual's foot on the scanner. The production-delivery phase still involves the time to manufacture and transport the footbeds to and from a central manufacturing site.

Consequently, while these footbeds are less expensive to manufacture than those by the gold standard, they are not economically feasible for use by a large number of individuals who have no significant foot abnormalities, but would benefit from such footbeds. To overcome this characteristic, several companies have developed systems with the expectation of providing a consumer with a shoe or footbed in which the costs involved with the measurement and production-delivery phases are minimized.

U.S. Pat. No. 5,237,520 (1993) to White discloses one such foot measurement and footwear sizing system. During a measurement phase, a consumer stands on a scanner at a retail store. The scanner derives three-dimensional topographical information about the consumer's feet. During the manufacturing-delivery phase, this three-dimensional information is processed to identify a matching manufactured footwear product that can be sent to a retail store for delivery to a customer. This shipment includes a last for use in subsequent manufacturing of custom footwear and footwear products at the retail store.

U.S. Patent Application Pub. No. 2007/0039205 (2007) to Erb et al. discloses two embodiments of a patient station or kiosk used during the measurement phase. In one, a foot measurement device is replicated on a floor and a vertical surface. In the other, the measuring device is on the floor only. Measurement devices include an optical scanner and a sensor for measuring pressure. Information derived from the measurement devices is converted into a shoe prescription that a store representative uses to construct a pair of shoes during the production-delivery phase. During this phase, additional structural adjustments to achieve consumer comfort may be necessary.

Erb et al. also disclose a method and system for identifying a kit of footwear components for assembly into customized footwear for a consumer. Specifically, the scanned foot measurements and other consumer provide a basis for printing a “prescription” by which a selection is made from a set of prefabricated footwear components.

U.S. Patent Application Pub. No. US2002/0138923 (2002) to Shaffeeullah discloses a method and apparatus for producing individually contoured shoe inserts at a local site. More specifically, apparatus at the local site a scanner generates data representative of the shape of the foot. This data is processed based upon characteristics of the consumer's foot, qualities the consumer desires and the manner in which the consumer walks. After the measurement phase ends, the modified data then transfers to a device for forming an insert by molding a blank template at the local site to produce a desired shape during the production-delivery phase. This system is disclosed as being operated by an individual other than the consumer. Moreover, although this system may minimize the time to complete the production-delivery phase, the replication of insert production apparatus at each local site can increase the production-delivery phase costs significantly.

Erb et al. patent could reduce the time and cost to the measurement and production-delivery phases. However, there is a possibility that the resulting in custom footwear may not be acceptable to the consumer. Specifically, in this system the foot is not aligned and is not in a supported position when the scanning occurs. Rather, in the Erb et al. patent a system, preferably with a foam mat, deforms under the weight of the individual. Thus scanning occurs when the foot is in a fully compensated position with the arch flattened and the foot elongated. Moreover, as feet generally are not symmetrical in the full compensated position because one foot may flatten more than the other so the feet are determined to be different sizes when, in fact, they are not. Although a system in accordance with Erb et al. might eliminate the need for a professional during the measurement phase, there is recognition that a consumer may be directed eventually to a podiatrist or other professional. The time and costs for the production-delivery phase are reduced because the shoe is assembled at the retail store. However, the retail store must bear the additional costs for a large inventory of shoe lasts and other components in order to minimize delivery time. Further, the actual time and cost during this phase are somewhat uncertain because the consumer determines when the shoes are acceptable. This is a very subjective test.

The White patent and Shaffeeullah applications disclose systems that could minimize the time and costs of one phase. However, they do not minimize the time and costs for both phases.

With respect to apparatus for performing the measurement phase, in the above-identified Peterson published applications a consumer sits and places a foot on an air pillow to be captured in a reference neutral position with the forefoot and midfoot locked against the rear foot. Then the air cushion is inflated until the practitioner notices that the heel lifts from a reference plane. When this occurs, the system scans the bottom of the foot. This scanning process produces accurate representations of the bottom topography of a consumer's feet and enables the production of accurate footbeds.

In the previously identified White patent, a white light scanner generates information about the bottom topography of a consumer's foot, apparently when the consumer is standing on the scanner. Reflected light is processed to obtain a pressure map based on the color of the reflected light and to obtain distance based on light intensity.

In U.S. Pat. No. 5,790,256 (1998) to Brown et al. matrices of pressure sensors and optical sensors measure feet in a full-weight bearing state. A digital signal processor normalizes and smoothes pressure data for display on a monitor. Other optical devices located around the perimeter of each foot measure the length, width and height of the foot. The data from both these sensor sets and devices is then manipulated to display orthotic prescriptions or insole selection information for use in the manufacture of footwear or footbeds.

U.S. Pat. No. 6,141,889 (2000) to Baum discloses a custom foot support and method for producing such a foot support based upon a scan of the foot in a full-weight, semi-weight or non-weight bearing state. An optical scanner produces a three-dimensional image of the bottom of the foot. The images from this scanner are then exported to a central system for use in the production of a footbed, along with data relating to the patient's sex, weight, age, foot type and shoe style. Some of this data is taken from tables based upon averages. It is unlikely that a modification based upon an average will produce the exact modification the patient requires.

U.S. Pat. No. 7,068,379 (2006) to Sundman et al. discloses an optical contoured digitizer for scanning a foot that provides laser scanning at a reduced cost. Specifically, the optically contoured digitizer includes a radiation source. A first mirror folds the emitted radiation toward an object being measured, such as a foot in a full-weight bearing state. A second mirror folds the reflected radiation to a sensor.

U.S. Patent Application Pub. No. US2005/0203712 (2005) to Lowe discloses a system in which a consumer stands on a pressure sensitive pad to produce signals concerning the shape or topography of the bottom surface of the consumer's foot. From this information a selection is made from basic orthotic shells that then can be modified to produce an orthotic.

In U.S. Patent Application Pub. No. US2006/0103852 (2006) to Klaveness a consumer places a foot on a membrane over a medium, such as a semi-transparent liquid, that is pressurized according to the consumer's weight. A scanner below the medium records light reflected from the membrane through the medium. As will be apparent, the scan is made with the consumer in a full-weight bearing position.

The Peterson published applications disclose a scanner that requires a practitioner to produce a valid image in a semi-weighted, supported position. When the air pillow is inflated, it pushes up on the plantar surface. This aligns and supports the foot structure and contains and supports foot tissue. When the foot is aligned and supported in this manner, the arch is in its anatomical position and anatomical height for the consumer. As previously indicated, measuring and scanning a foot in the full-weight or semi-weight compensated position leads to a footbed in a misaligned compensated position. Consequently, the footbed will not align and support the foot correctly.

With respect to the production-delivery phase, the prior art discloses different footbed structures. The previously identified Peterson published applications disclose a footbed that includes a bottom portion formed of a heel post stabilizer and a forefoot stabilizer. An orthotic lies on the post heel stabilizer and a portion of the forefoot stabilizer and may include a metatarsal pad and a forefoot post. A top cover then forms a laminated structure. The shipped orthotic thereby contains all the structures that are necessary to position the individual's rear foot and midfoot in a correct position.

International Publication No. WO98/52435 (1998) to McRoskey discloses adjustable orthotics comprising orthotically functional and interchangeable components. The interchangeable components are inserted into a main body after which a cover overlies the components.

U.S. Pat. No. 3,084,695 (1963) to O'Donnell discloses an arch supporting cushion inner sole. The inner sole has an intermediate sheet of sponge rubber having curved channels that define segmental areas. Selected pads are interposed between upper and lower plies whereby the pads form bulges at various areas.

U.S. Pat. No. 4,841,648 (1989) to Shaffer discloses a personalized insole kit. An insole has a surface that contains a plurality of shapes, each disposed for a specific correction. Each shape is contained on the surface of the insole by hooks and loops. The insole is marked to identify a correct location for each component. This patent specifically discloses an insole with an arch pad, a heel pad, a metatarsal pad and a corn/callous/lesion pad.

U.S. Pat. No. 5,832,634 (1998) to Wong discloses sports footwear with a sole unit that comprises at least one composite material layer partly involving the sole unit itself. Specifically the sole comprises at least one portion formed of woven composite material having a part positioned in correspondence with the metatarsal region of the user's foot and a part at a position corresponding to the arch region of the foot. The portion in the metatarsal region is flexible. The part in the plantar arch region is rigid.

The previously identified Erb et al. published application discloses footwear components selected from a plurality of pre-manufactured footwear components having substantially the same function, but having different physical attributes to accommodate different foot configurations. These include arch supports and heel pads.

In summary and as previously indicated, the Peterson published applications provide high quality orthotic footbeds. However, the costs, in time and expense, for each of the measurement and production-delivery phases are high and preclude its application to a major market. Other prior art approaches reduce the time and costs associated with some of these phases, but generally at a reduced quality, particularly in the quality of the information provided the measurement phase.

For example, the Peterson patent applications disclose measurements taken in a semi-weight bearing state. Measurement techniques that scan the feet under a full-weight bearing state can produce incorrect arch measurements. As will be apparent, arch height and length vary with weight. In a full-weight bearing state arch height is at a minimum and arch length is at a maximum. In a non-weight bearing state arch height is at a maximum and arch length is at a minimum. An intermediate and more accurate measurement occurs when the foot is in a semi-weight bearing state. Moreover, whereas the Peterson published applications disclose the use of an air cushion to capture a foot in a semi-weight bearing position; other references disclose full weight bearing with an attendant distortion on the bottom of the foot as the tissue spreads under weight.

What is needed is a system for providing method for producing footbeds for consumers in which a measurement occurs locally without the requirement for any professional assistance and yields accurate information about a consumer's feet. The system should identify an inner sole base member, an arch support and a metatarsal pad having appropriate properties based upon these measurements. The construction of a footbed should then be based upon a selected inner sole base member, arch support and metatarsal pad that is easily assembled by the consumer from an inventory at the site thereby to further minimize the cost of footbeds, even though the quality of these footbeds approaches the quality of orthotic footbeds made by either the gold standard method or by the methods in the Peterson published applications.

### SUMMARY

Therefore it is an object of this invention to provide a method and system for providing low cost, high quality footbeds to consumers.

Another object of this invention is to provide footbeds to consumers at a minimal cost.

Still another object of this invention is to provide a method and apparatus for producing footbeds in which the consumer foot measurements do not require practitioner assistance.

Yet another object of this invention is to provide a method and apparatus for producing a footbed that the consumer can assemble.

Yet still another object of this invention is to provide a method and apparatus that enables the construction of a footbed with minimal costs associated with the measurement and production-delivery phases.

Still yet another object of this invention is to provide a measurement method and apparatus that can be used by a consumer without assistance.

Still another object of this invention is to provide a production method for footbeds that is easily performed at a local site.

In accordance with one aspect of this invention a method for obtaining measurements for use in the construction of a footbed for a consumer includes the step of generating foot images of each of the consumer's feet. For each foot further measurements are made by projecting the corresponding foot image at a measurement position. A consumer places a foot on the image to enable capturing of the foot at the measurement position in a position essentially aligned with the projected foot image. An array of measurements representing the topography of the individual's foot is converted into information for producing a footbed for the individual's foot.

In accordance with another aspect of this invention, a footbed is provided for an individual's foot characterized by forefoot, rearfoot, lateral and medial column, arch and metatarsal head areas. The footbed includes an insole base, a metatarsal pad insert and an arch support insert. The insole base is taken from a group of insole bases for underlying the forefoot and rearfoot areas and portions of the lateral column area between the forefoot and rearfoot areas. The insole base has a vacuity substantially coextensive with the areas underlying the arch and metatarsal head areas and portions of the medial column area. The metatarsal pad insert is taken from a group of metatarsal pad inserts of different properties. The arch support insert is taken from a group of arch support inserts of different properties. The inserts are attached to the insole base to span the vacuity and to provide support for the metatarsal head and arch areas of the foot, respectively.

In accordance with still another aspect, this invention provides a method by which a consumer at a store can obtain a footbed with characteristics that are adapted for the consumer's feet. There is an inventory of footbed components at the store. They are organized into a plurality of groups, each with at least one subgroup. The components in each subgroup have certain characteristics. The consumer is guided through a measurement phase during which the consumer enters personal information into the system, generates a pressure map of both feet, generates a topographical map for each foot. The system then generates a list of one component from each subgroup for each foot. Thereafter the consumer gathers each component on the list from the inventory for assembly into footbeds.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a pictorial representation of a network of local sites that include kiosks for enabling the assembly of footbeds in accordance with this invention;

FIG. 2 is a functional diagram of operations that occur within the apparatus of FIG. 1;

FIG. 3 is a perspective view of a kiosk shown in FIG. 1;

FIG. 4 is a section view taken along lines 4-4 in FIG. 3;

FIG. 5 is an enlarged sectional view of an optical subassembly in the kiosk of FIG. 3;

FIG. 6 is a view of a portion of an air pillow shown in FIG. 5 with foot position controls;

FIG. 7 is a schematic diagram of one embodiment of hardware system components for the kiosk in FIG. 3;

FIG. 8 is a flow chart disclosing the operation from a consumer's perspective;

FIGS. 9A through 9L comprise a representative set of screens for display in connection with the flow chart of FIG. 8;

FIG. 10 is a basic flowchart that defines one procedure for processing the data obtained during the measurement phase;

FIG. 11 is an exploded perspective view of components for a footbed produced in accordance with this invention;

FIG. 12 is a perspective view of a footbed constructed with the components of FIG. 11 in accordance with this invention;

FIG. 13 is a perspective view of an arch support insert component taken from one side;

FIG. 14 is a perspective view of an arch support insert component taken from other side;

FIG. 15 depicts a sample set of components for forming a footbed as shown in FIG. 12;

FIG. 16 is a cross-sectional view taken along lines 16-16 in FIG. 15;

FIG. 17 is a cross-sectional view taken along lines 17-17 in FIG. 15;

FIG. 18 is a chart that depicts a typical component inventory at a local site; and

FIG. 19 is a simplified flow chart illustrating the process of identifying specific footbed components from an inventory as shown in FIG. 18 in response to the data provided by the processing of FIG. 10.

### DESCRIPTION OF ILLUSTRATIVE EMBODIMENTS

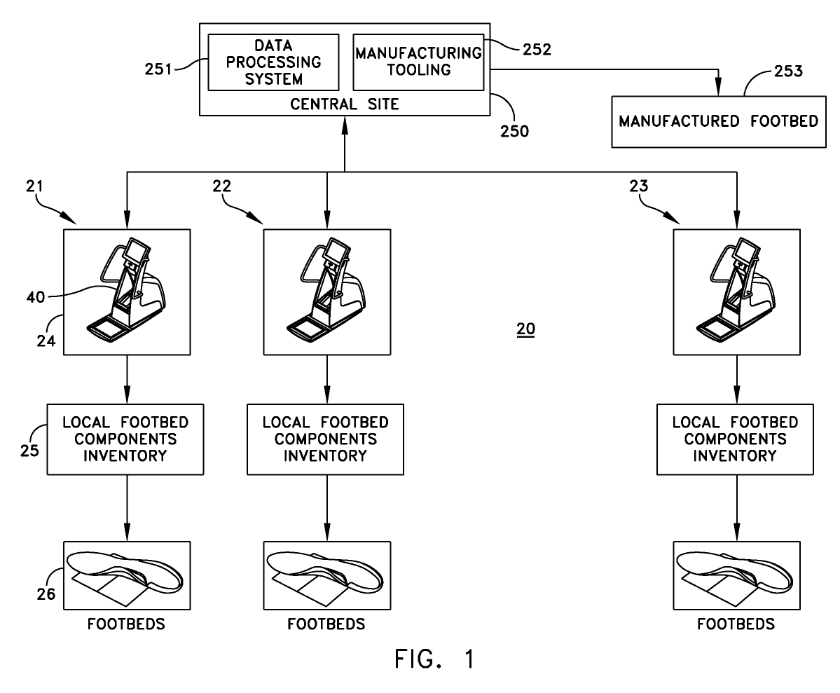

The various objectives of this invention are achieved by increasing the efficiency of both the measurement phase and the production-delivery phase for providing a consumer with a set of footbeds adapted for the topography of the consumer's feet. FIG. 1 depicts a network 20 for producing footbeds in accordance with this invention that includes a kiosk for performing the measurement phase. FIG. 1 discloses multiple remote or local sites 21, 22 and 23, typically each at a different retail store. Site 21, as an example, includes a measurement station 24 and a local inventory of footbed components 25 from which individual components are selected for assembly into footbeds 26. The measurement station 24 provides information on which to base this selection of components.

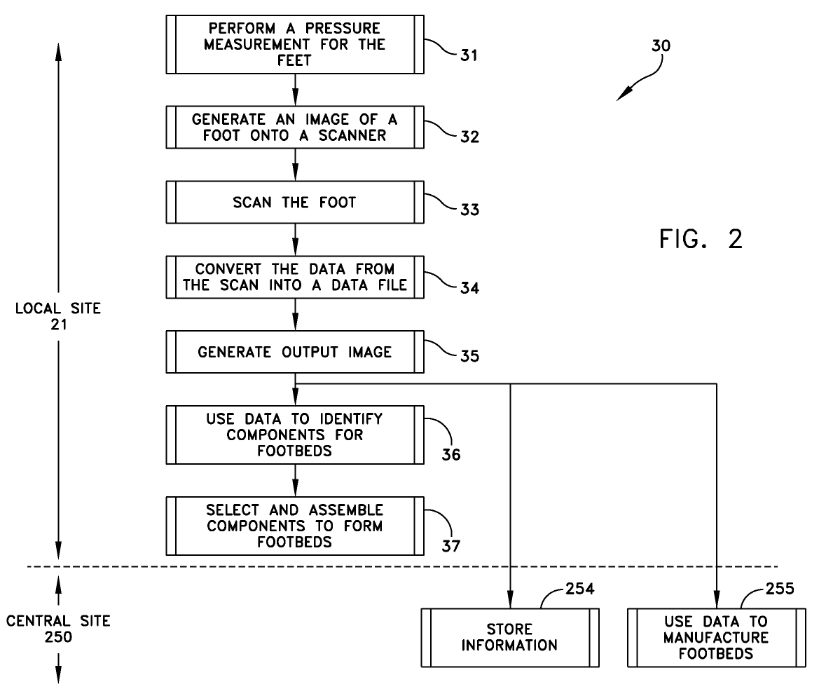

As shown in FIG. 2, the operation 30 that constitutes the measurement phase includes a number of processes. A process 31 performs a pressure measurement of the consumer's feet for the purpose of generating an image of each foot. When that information has been obtained, process 32 projects an image of a foot onto equipment that captures the foot in a position essentially aligned with the projected foot image. Typically this equipment will include a scanner.

Next, the consumer places a corresponding foot onto the scanner in registration with the projected foot image thereby locating the foot in a semi-weighted supported position. Process 33 then scans the foot to produce an array of measurements representing the topography of the bottom of the consumer's foot. Process 34 converts that array of measurements into a data file for further processing. Process 35 produces an output image and other information for the consumer. Processes 32 through 35 are repeated for the consumer's other foot.

Process 36 uses the information from both feet to identify components for the footbed and provides a list of those components. Process 36 represents the production-delivery phase during which the consumer obtains the identified components from the local inventory. The consumer then can easily assemble the components into footbeds that closely approximate ideal footbeds for the consumer.

As will be apparent, all the data processing occurs at the local site. As will also become evident, the consumer can be simply directed or guided through this entire operation without assistance from store personnel or practitioners. Moreover both the measurement phase and the production-delivery phase require only a few minutes to complete. As a result finished footbeds are available to the consumer quickly. The reduction in personnel requirements and the existence of a local inventory of components minimizes the costs associated with the production-delivery phase and enables such a footbed to be provided to the consumer at a reasonable cost.

### Kiosk 40

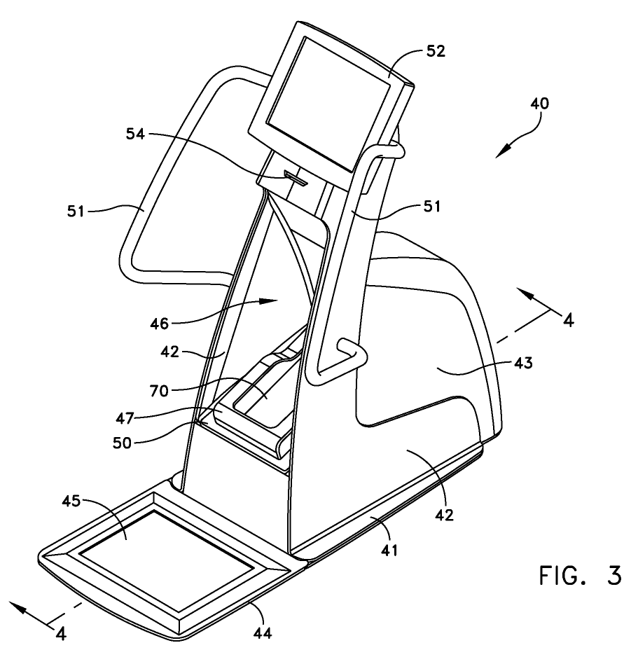

The measurement phase involves interaction between the consumer and a kiosk 40 shown in FIG. 1 and in greater detail in FIGS. 3 through 5. One such kiosk 40 includes a base 41 and a frame 42 with an enclosing housing 43 that opens to the front. In this implementation a detachable base extension 44 extends forward from the base 41 and contains and supports a pressure sensing mat 45. The pressure sensing mat 45 provides a continuous, relatively thin surface that measures distributed pressures along its contact surface. As an output the pressure sensing mat 45 produces an array of pressure signals that are used to produce a pressure map. Such a map shows distributed contact pressures either as a 3D contour map or a 2D color map. While a variety of different pressure sensors can be utilized, it has been found that a pressure mat with a resolution of about 10 mm×10 mm and a full area scan rate of about 10 Hz provides adequate spatial and temporal resolution. Such pressure mats are available from a number of commercial dealers, such as Pressure Profile Systems.

The frame 42 and housing 43 define a cavity 46 that carries a foot pillow assembly 47 based upon the pillow assembly shown in co-pending U.S. Pat. App. Pub. No. US2006/2083243. In this kiosk 40, the foot pillow assembly 47 resides on a base 50 that elevates the toe portion above the heel portion at an angle α that minimizes the consumer's physical exertion and effort in maintaining balance during a scan. Although the angle α can be in a range of about 10°≦α≦30°, in the specially disclosed implementation, α≈20°. Spaced, generally vertically extending parallel handle bars 51 attached to the frame 42 assist the consumer in maintaining balance.

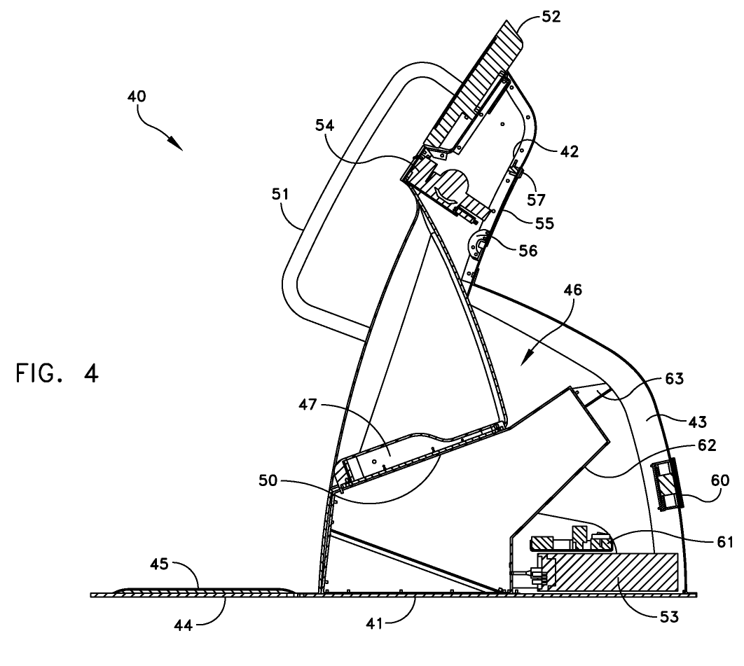

FIG. 4 depicts the kiosk 40 in greater detail. A consumer who is standing on the pressure mat 45 can easily interact with a touch screen monitor 52 that constitutes an input-output device for a computer 53. A printer 54 positioned below the touch screen 52 provides a hard copy output as described later. Access to the printer 54 for replacing paper is through a rear door panel 55 that pivots about a hinge 56. A lock 57 prevents unauthorized access to the interior of the kiosk 40. Toward the bottom and back of the frame 42 and the housing 43, an exhaust fan 60 provides cooling for the computer 53 and other equipment. An air pump assembly 61 with a valve interacts to inflate or deflate a bladder in the foot pillow assembly 47. A housing 62 encloses optical paths defined by equipment on a bracket 63.

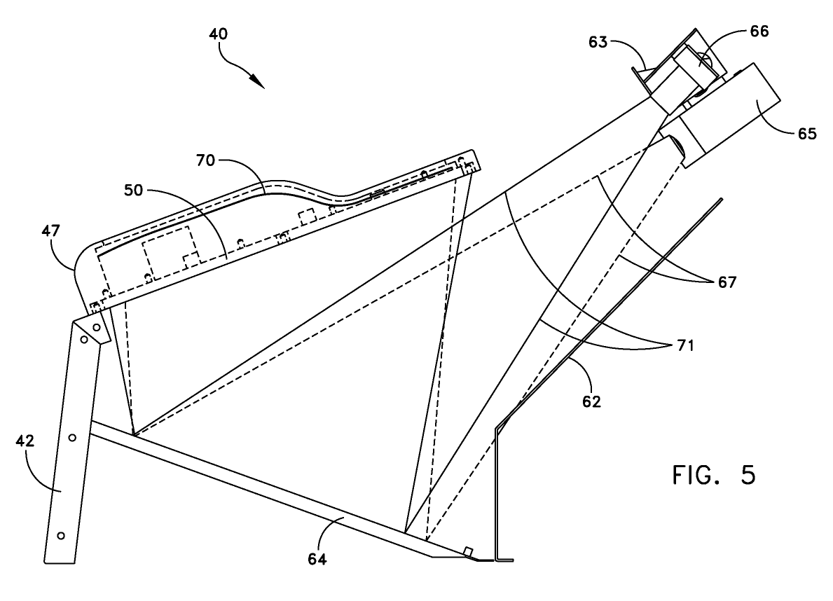

Referring now to FIG. 5, the bracket 63 lies above a mirror 64 also supported by the frame 42. The bracket 63 carries two components. A projector 65, such as a DLP projector, is an output device for the computer 53. In one implementation the light source in the projector 65 is an LED light source. A camera 66 constitutes an input device to the computer 63.

The mirror 64 inclines downward from front to back such that the mirror 64 diverges from the transparent portion of the foot pillow assembly 47. The mirror 64 can take a number of forms, but a front surface mirror is particularly adapted for rear projection to prevent optical distortions inherent in second surface mirrors.

Still referring to FIG. 5, the projector 65 projects an image as shown by rays 67 that reflect from the mirror 64 through the transparent portion 50 of the foot pillow assembly 47 to be incident on a translucent membrane 70 that is part of the foot pillow assembly 47 and that defines a flexible or expandable upper boundary of the bladder. Light reflected from the underside of the membrane 70 reflects off the mirror 64 to be directed along an optical path bounded by rays 71 to the camera 66.

The projector 65 and camera 66 have different operating modes. In one operating mode, the camera 66 is inactive and the computer 53 causes the projector 65 to project an image of one of the consumer's feet onto the membrane 70. During the operating mode for determining the topography of the consumer's foot, the projector 65 produces, under the control of the computer 53, a series of patterns that reflect from the bottom of the consumer's foot to the non-active camera 66 acting as a frame grabber. As described more fully later, these frames are then processed to produce the list of selected footbed components.

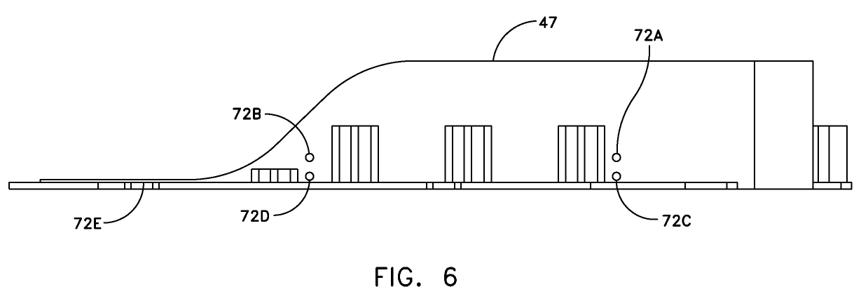

Referring now to FIG. 6, the foot pillow assembly 47 operates by being inflated thereby to move the membrane 70 into intimate contact with the bottom of the consumer's foot. During inflation it is important that the foot just lift off the transparent portion 50. FIG. 6 depicts one control implementation in the form of an array of position sensing circuits, or position detectors, 72A through 72E. Each photodetector system includes an infrared LED emitter and a detector on opposite sides of the air foot pillow assembly 47. Vertically aligned position detectors 72A and 72C are proximate the heel area; vertically aligned position detectors 72B and 72D, the toe area. Position detector 72E controls the forward position of the foot on the membrane 70. These position detectors are used in conjunction with the information supplied to the touch screen 52 in FIG. 4 to provide feedback to the consumer with respect to correct foot positioning for a scan.

The consumer's foot is considered to be in a semi-weighted support position when photodetectors associated with position detectors 72C, 72D and 72E receive light from corresponding sources and while the foot blocks light from photodetectors at the position detectors 72A and 72B. The semi-weighted support position extends over a small range of positions including the reference-neutral position defined in U.S. Pat. App. Pub. No. US2006/0283243. Consequently, information about foot topography with this system is closely analogous to that obtained with the apparatus shown in the above-identified publication.

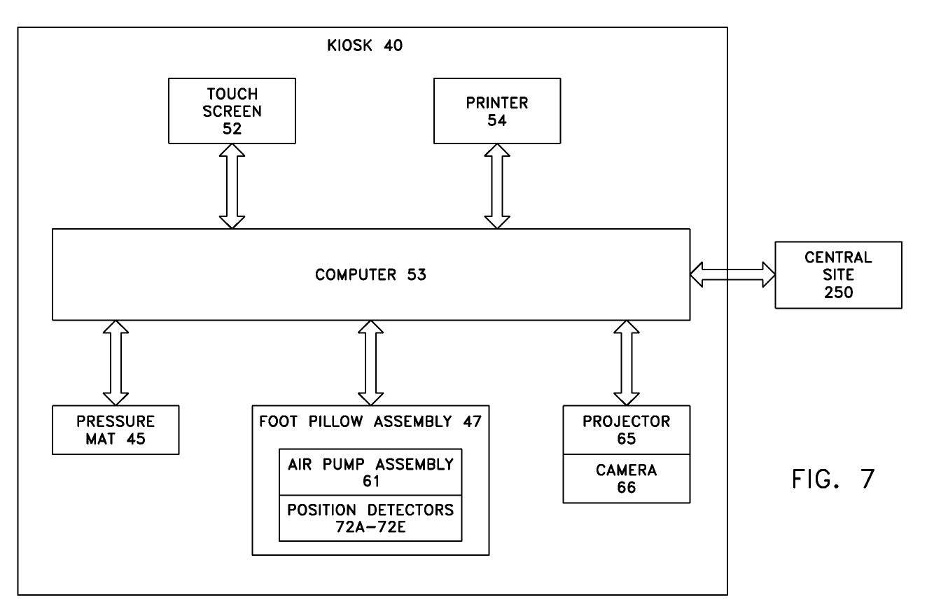

FIG. 7 depicts the organization of hardware components at the kiosk 40. Communications over the various paths between the computer 53 and each of the other components at the kiosk 40 occur over conventional data paths. Programs or program modules in the computer 53 control the interaction among the various hardware components including the acquisition of measurement information, the processing of that information and the selection of components in a local inventory.

### Operation

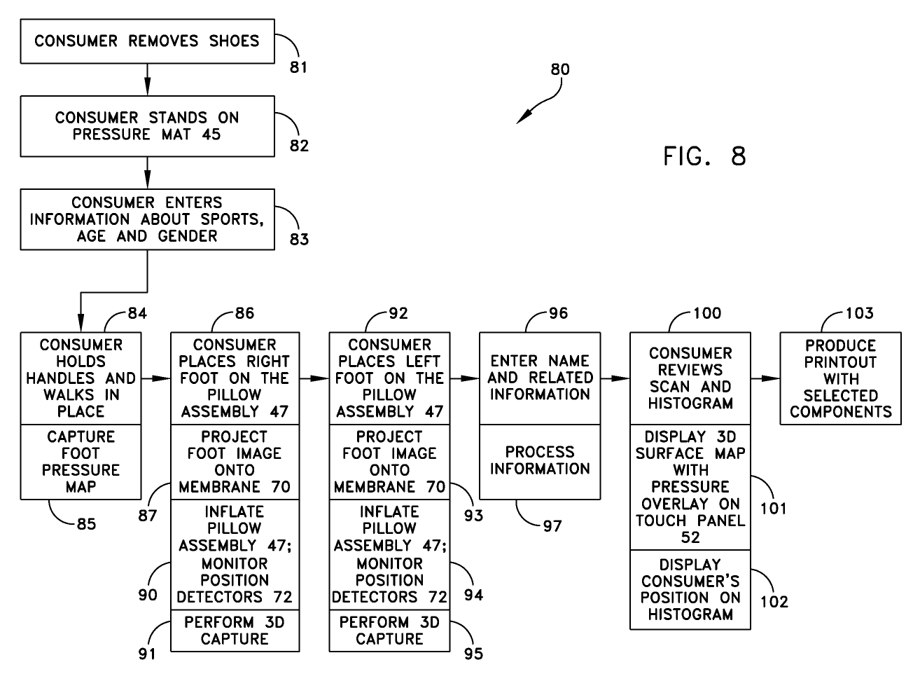

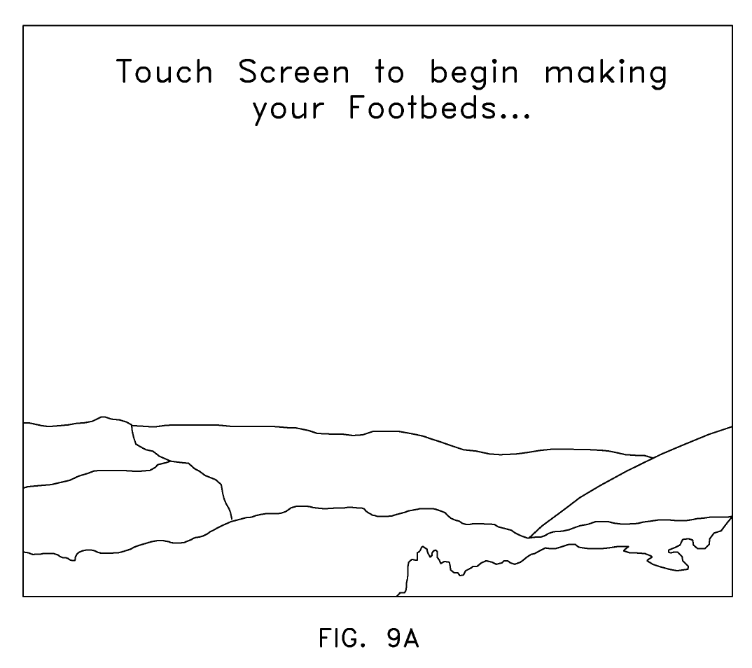

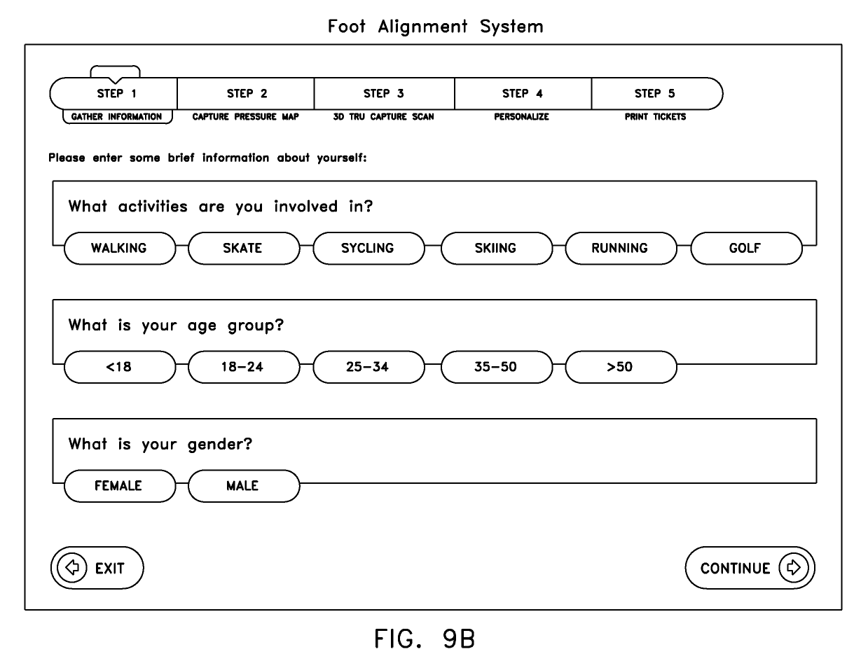

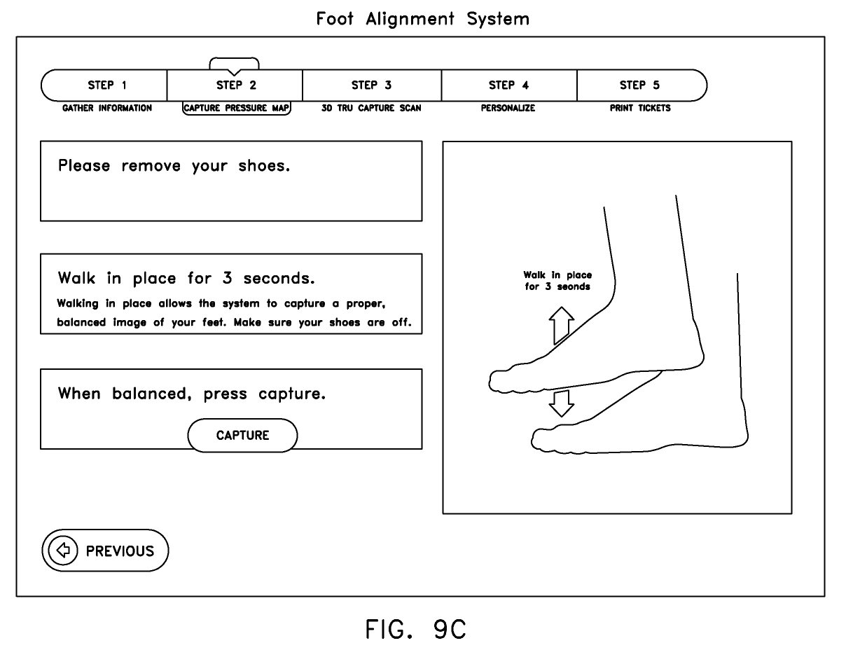

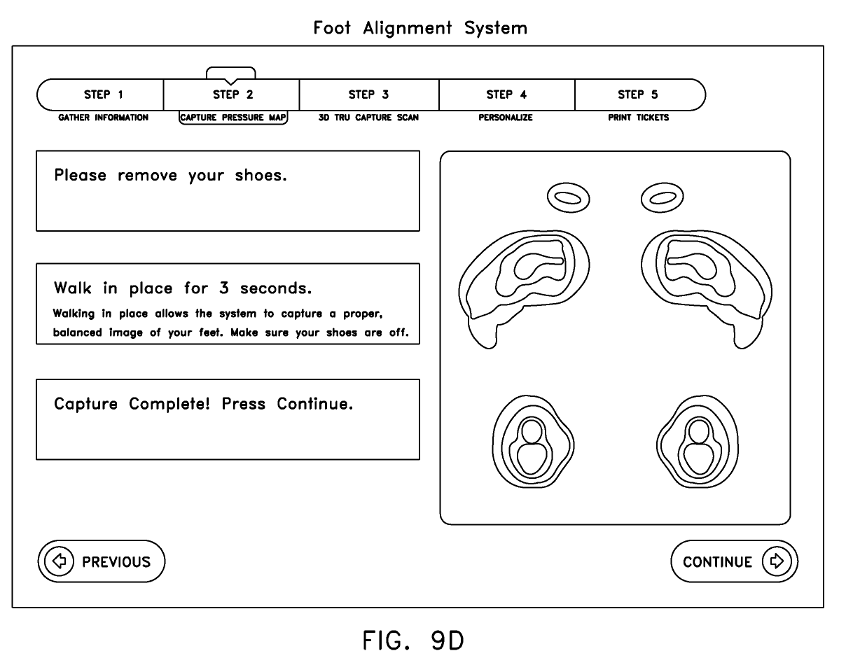

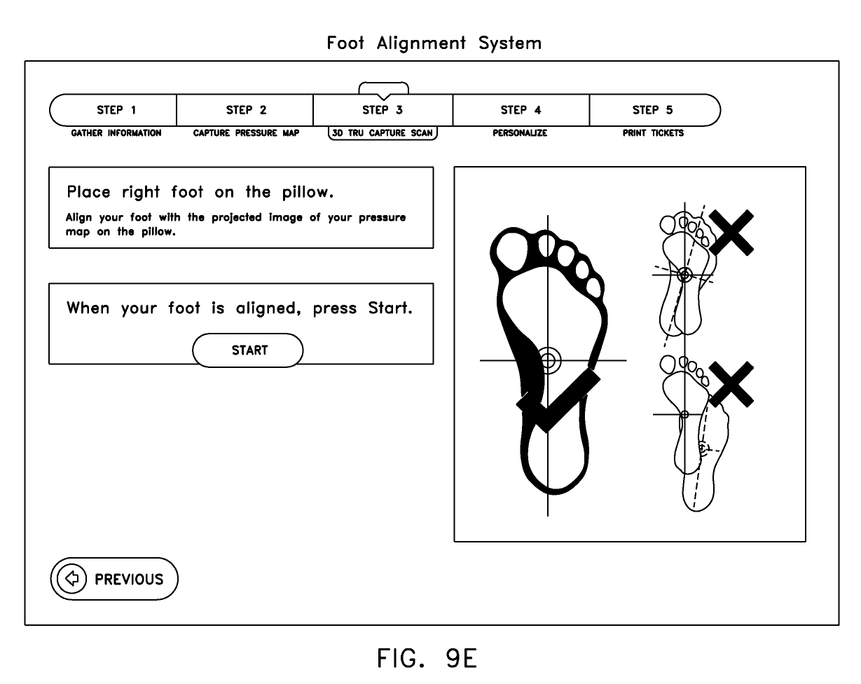

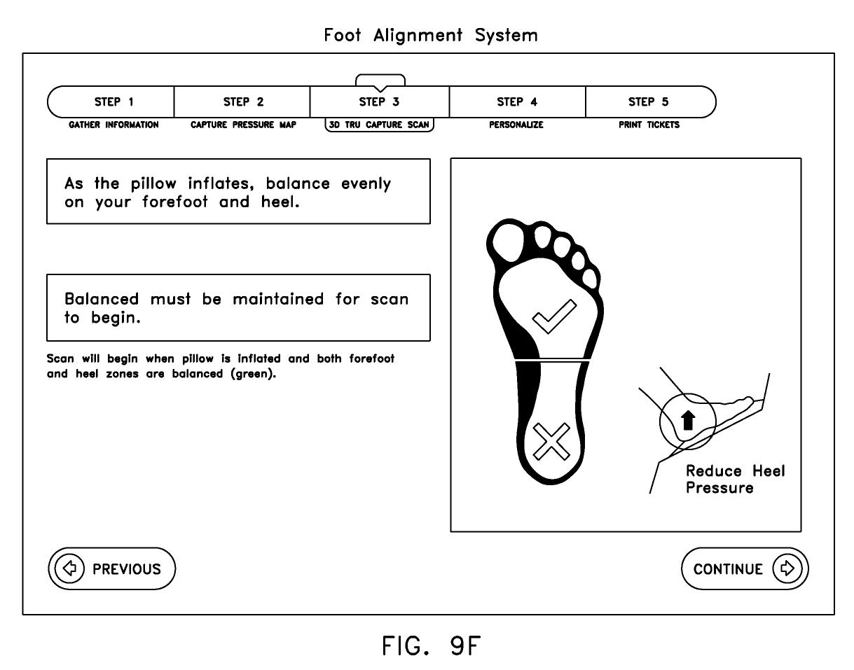

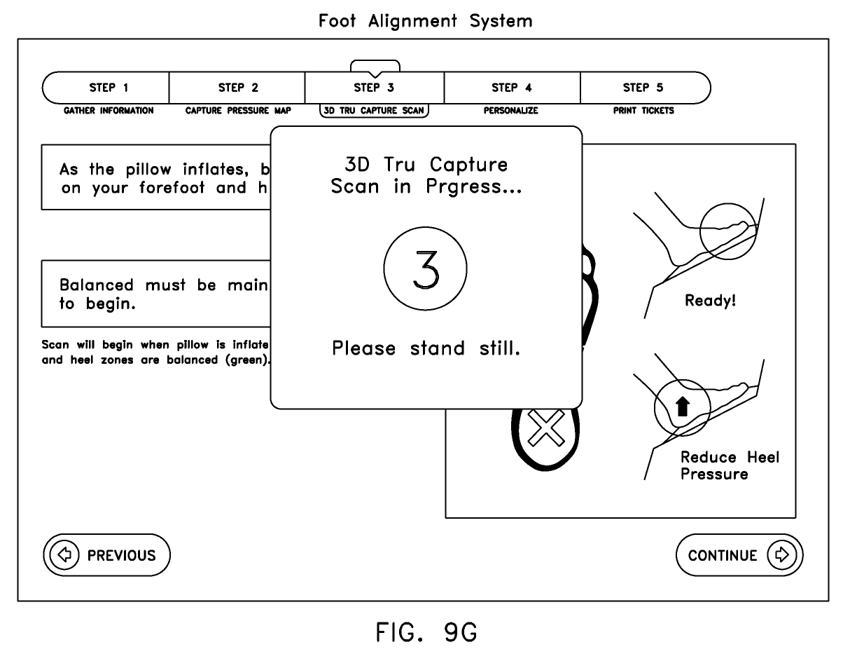

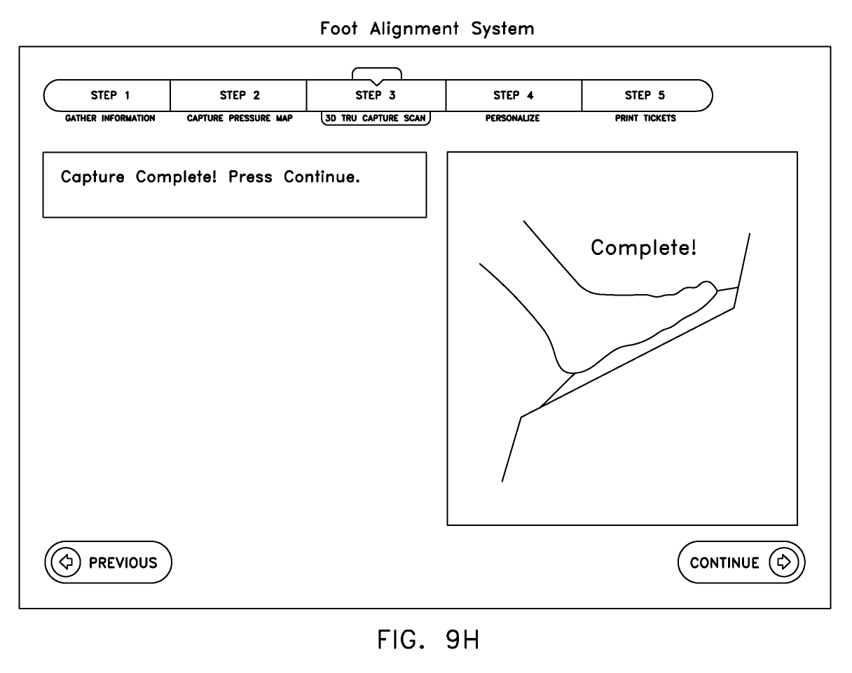

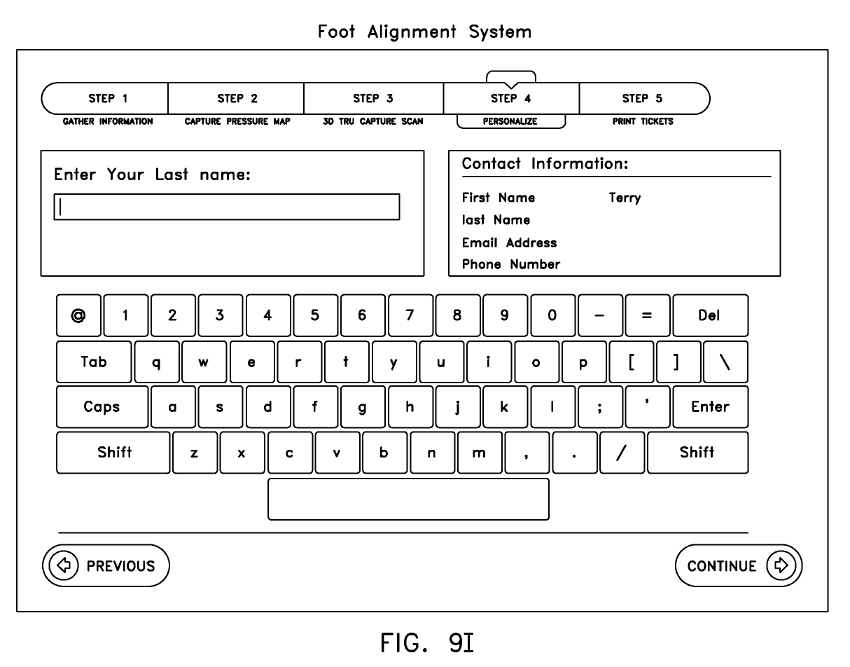

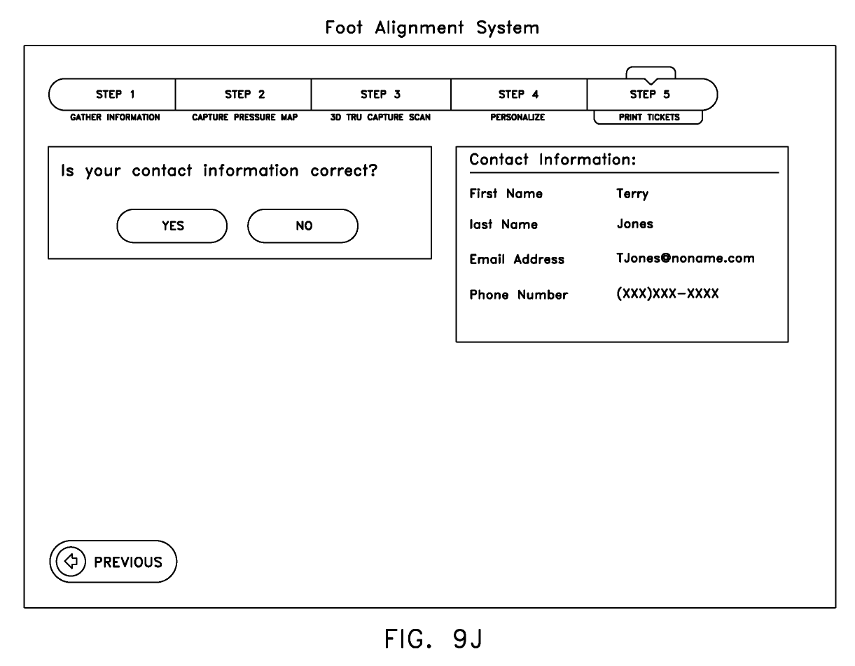

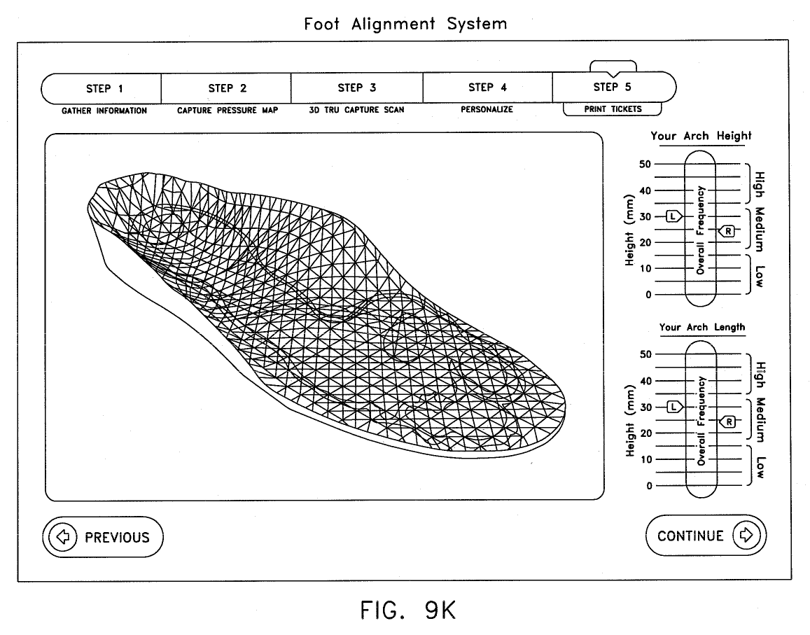

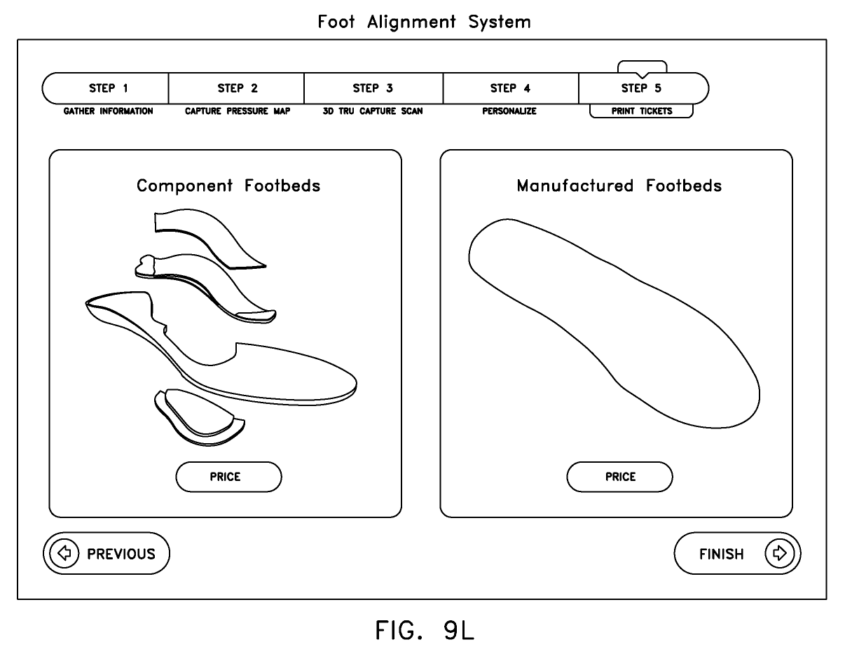

A more thorough understanding of the operation of the system depicted in FIG. 7 can be attained by describing the operation from the prospective of a consumer along with a description of the corresponding operations within the computer 53. FIG. 8 depicts this operation as a flow chart. Specifically, as a first step 81 the consumer removes his or her shoes. Then the consumer stands on the pressure mat 45 of step 82. At this time the touch screen 52 displays a main screen as shown in FIG. 9A. When the consumer touches the screen 52, the operating system displays a screen such as shown in FIG. 9B. Now, as shown at step 83, the consumer adds basic information including activities, age group and gender. The process of selecting the footbed components may use some or all of personal information depending upon the sophistication of an analysis.

When the consumer activates the CONTINUE icon in FIG. 9B, the scene of FIG. 9C requests the consumer to walk in place for a short interval (e.g., 3 seconds) as a specific example, normally grasping the handle bars 51. Walking for a few seconds naturally brings the consumer into a balanced position. During this interval step 85 dynamically captures foot pressures based upon the signals from the pressure mat 45. In step 85 an application retrieves the data from the pressure mat as an array of signals representing the force at each sampling position on the map. Using conventional techniques, this application converts the displacement signals into a map for the consumer in which different pressures are identified for example by different colors. Such processing is conventional and well known in the art. When the images have been processed, they then can be saved and converted into a format that will enable the projector 65 to display one or the other of the images at the foot pillow assembly 47.

Once the tactile image shown in FIG. 9D has obtained, step 86 causes the system to display the screen of FIG. 9E that directs the consumer to place one foot on the membrane 70; in this specific example, the right foot. As part of this process, step 87 causes the projector 65 to project the image of the consumer's right foot taken from the tactile images onto the membrane 70. Once the consumer's foot is in position, the control system first generates a signal that closes a valve and energizes the air pump 61 until the position detector array 72 indicates that the foot on the membrane 70 is in the correct position. At the end of the scanning operation another signal opens the valve to exhaust the bladder under the membrane 70.

When the consumer actuates the START button in the screen of FIG. 9E, the screen of FIG. 9F appears. This screen provides feedback based upon the position detector array information to indicate whether the consumer has his foot in an appropriate position. If there is too much heel pressure, that is if the heel interrupts both the position detectors 72A and 72C, the control system displays a need to reduce heel pressure. Conversely, if the consumer's heel is too high so that light passes under the heel both the position detectors 72A and 72C, the screen indicates heel pressure should be increased. Similar tests would be conducted with respect to the position detectors 72B and 72D and with respect to the position detectors 72E.

When the screen in FIG. 9F indicates that balance has been achieved, step 91 initiates a 3D scan. During this interval the system displays the screen of FIG. 9G. When the capture is complete, the control system displays the screen of FIG. 9H. Once this occurs the process can repeat for the other foot as shown in steps 92 through 95. After the second capture has been completed in step 95 and the consumer activates the CONTINUE icon on the screen of FIG. 9H, the touch panel displays screen 9I which requests additional personal information. Entry is by conventional processes during step 96.

During this time the measurements established in steps 85, 91 and 95 begin to be processed in a background mode at the signal processing step 97 as described later. When the consumer completes the entry of information in FIG. 9I activating the CONTINUE icon displays a validation screen as shown in FIG. 9J. If the information is not correct, the program displays screen 9I again and enables information to be edited. Once the consumer confirms the contact information, the system displays the screen of FIG. 9K that allows the consumer to review and scan two histograms as shown in step 100. An upper histogram depicts the consumer's arch heights to the average arch height. The lower histogram depicts the consumer's arch lengths to the average arch length.

Specifically, the screen in FIG. 9L displays a surface map 104 with a pressure overlay on the touch panel 52. In addition the system displays information concerning arch height at 105 and arch length at 106 with a comparison to historical measurements. When the system completes processing, the consumer then can activate the CONTINUE icon and display the screen of FIG. 9L. The screen of FIG. 9L enables the consumer to select either a footbed in accordance with this invention or the production of a custom footbed at a remote location. Next, the printer 54 in FIG. 7 produces a ticket that identifies the consumer and the scan to enable on-line access to the consumer's data. If the consumer elects to proceed local production of the footbed, the printer 54 also identifies the various components that should be combined to form each footbed.

### Signal Processing

As previously indicated, step 97 in FIG. 8 processes the scan and personal information to obtain a list of the appropriate footbed components. Various processes might be used. In accordance with one implementation the various data points received from the 3D capture processes of steps 91 and 95 are considered to be point clouds. Step 110 in FIG. 10 centers the point cloud and removes outliers. More specifically, step 110 subtracts the mean of the point cloud to make it zero-mean. If the point cloud is associated with the left foot, the y-coordinates are flipped in sign. Step 110 also removes points in the cloud that lie outside a rectangular box in the x-y plane that corresponds in size to be larger than the largest foot to be measured (e.g., ±120 mm in a front-back direction and ±50 mm left-right from center). Next step 110 subtracts the mean of remaining point cloud to make the remaining set zero-mean. Step 111 rotates the foot point cloud until the foot is aligned with a Z+ axis that is, it is upright and the bottom of the foot approximates a value Z=0 that is at the x/y reference plane.

In one implementation based upon the eigenvalues of a set, the pressure data is segregated into horizontal rows to obtain the centerlines of pressure points produced while the consumer stands on the pressure mat 45 in FIG. 3. Step 111 then processes the data to find the edge of the foot to define pressure points at the metatarsal head and heel regions of the consumer's foot. A reference line is established, generally spaced from the connecting line. The image of one foot is then translated until one of the defined pressure points is coincident with the line. Then the image is rotated until the other pressure point is also coincident with the line. In this configuration, the foot image is theoretically aligned with the center line of the scanner assembly 47. In practice, there may be a small deviation because a line between the two pressure points will not be parallel to a conventional center line through the foot. However, the deviation is not significant and does not adversely impact the positioning of the individual's foot or the measurement results.

In an alternate implementation, step 111 performs an iterative process until convergence. In this process, a 2-component Gaussian Mixture Model (GMM) is fit to the z-coordinate data. Then only those points with z-coordinates towards the bottom of the foot are selected (e.g., those points having a threshold at maximum of the two means minus two times the corresponding standard deviation). A Principal Component Analysis (PCA) of the selected 3D points with a check of the angle between the third eigenvector (smallest eigenvalue) and the z⁺ vector [0;0;1]. This resulting coordinate frame is rotated using the Rodriguez formula such that the third eigenvector aligns with z⁺. Convergence occurs with the angle reaches a predetermined threshold or the number of iterations exceeds a predetermined value.

In either case, after the rotation value is obtained, a determination is made of the location of the plane that touches the foot from the bottom (specifically this plane is assumed to be located at mean plus two times the standard deviation of these points). With this information, the point cloud is shifted such that the bottom plane coincides with z=0.

Step 112 identifies the heel, the center of the foot and the centers of the metatarsals. Again, in one specific implementation, step 112 fits a 3-component GMM with spherical covariances to the x-y plane projection data of the point cloud (starting from initial conditions that place the component centers near the heel, in the middle, and near the metatarsal area). These points are named p₁, p₂ and p₃, respectively.

Step 113 then determines a trapezoidal boundary for the arch region in each foot. In an implementation that is complementary to the operation of step 112, step 113 determines three line segments corresponding to boundaries of the arch region. One line segment passes through p₁ in the direction of x (points with y>p_{1y}). A second line passes through p₂ in the direction of y (points with x>p₁ₓ). The third line segment passes p₃ in the direction of y (points with x<p₃ₓ). The fourth side of the arch is determined using polynomial fits by partitioning the arch region into a number of equally spaced strips with respect to the x-coordinates. Then polynomials of order four are fit to the y-z data for each strip. The second derivative (quadratic) polynomial is set to zero and the root with the larger y-value is picked. Once all such roots are obtained from the strips, a median filter is applied to the y-roots and a line is fit to the x-y data (x-center of each strip and its corresponding root of polynomial). This line is the fourth boundary of the arch and typically completes a trapezoid with the other three line segments.

Next, step 114 uses a polynomial fit to the point cloud to obtain an estimate of the arch height using procedures corresponding to those described with respect to step 113, but with the various steps altered to correspond to the y axis. In this case step 114 fits a parabola to the x-z data and identifies the x-coordinate at which the parabola peaks. Next, the parabola that has the highest peak and a portion of the point cloud whose x-coordinates lie within a predetermined range that are selected to generate the highest peak and dimension of the range in the x direction. This portion of the point cloud roughly corresponds to the region of the arch where the height is maximum. A parabola fitting process applied to the y-z values of the points in this portion of the arch and an evaluation of parabola height at the outer edge of the arch provide the fourth boundary for determining arch height.

Step 115 constructs Delauney triangulation for each arch region in the point cloud and removes various triangles. With this information step 115 calculates a variety of surface area and volume features. These include various coordinates and values determined in steps 110 through 114, including arch length, area and volume values, and arch height values.

Next step 116 uses standard techniques to combine the features obtained in step 115 into summary features for arch height and arch length to produce values of true anatomical arch height and shoe size.

Step 117 then converts the information provided by step 116 into specific values for arch height and shoe size and from which component selection can be made. Specific values are represented with two corresponding and jointly Gaussian densities where the appropriate Gaussian model is selected depending on gender and parameters trained using a laser scan database. The laser scan database that has been developed from scans taken by apparatus according to U.S. Pat. Pub. No. US2006/0283243 contains appropriate information derived from thousands of scans. These joint densities yield conditional Gaussian densities corresponding to an output of the mean arch height and shoe size and a standard deviation for each. The standard deviations provide confidence intervals for mean arch height and shoe size. The conversion of this information to a list of footbed components is better understood after a discussion of the various features of a footbed structure. In addition, step 117 generates an arch length value.

### Footbed and Components

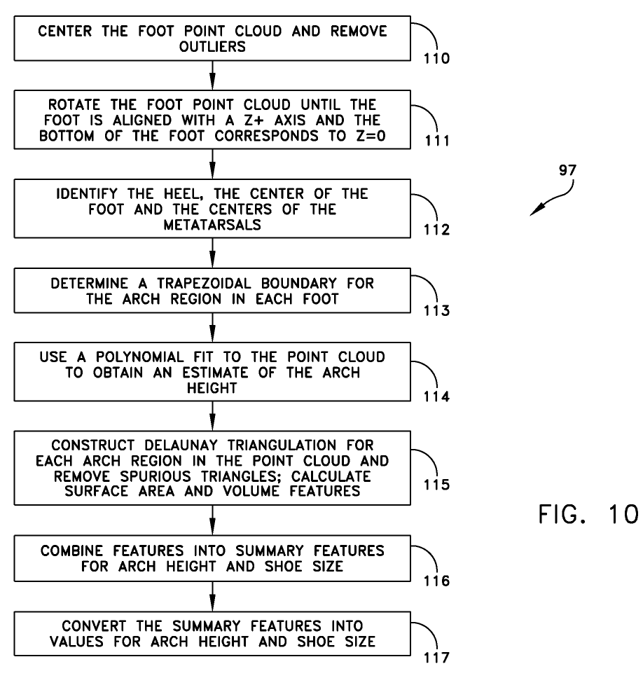

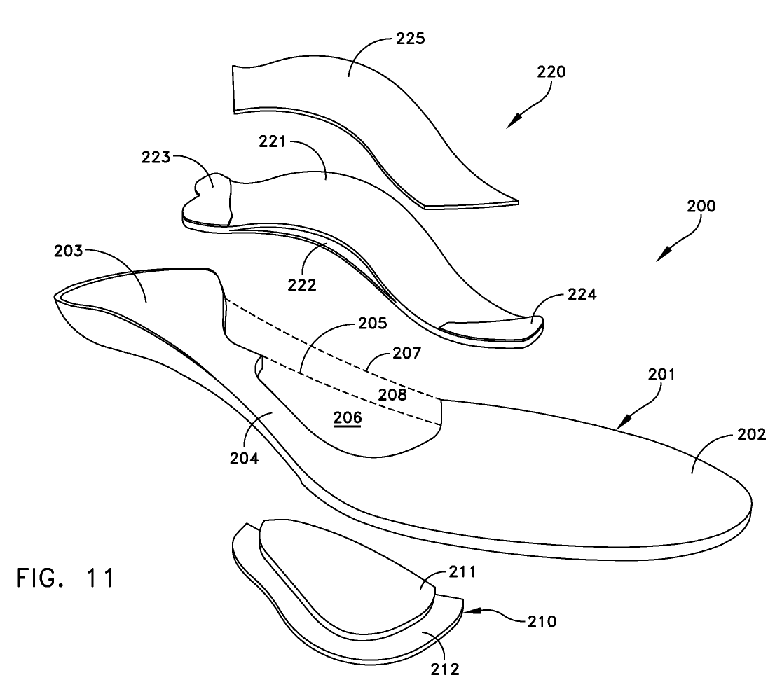

As shown particularly in FIGS. 11 and 12, a footbed 200 in accordance with this invention includes an insole base 201 with portions underlying the consumer's foot. These include a forefoot portion 202, a rear foot portion 203 and a connecting member 204 between the forefoot portion 202 and the rear foot portion 203. The rear foot portion 203 includes a cup-shaped heel structure for supporting and containing the consumer's heel and related tissue. The connecting member 204 is coextensive with a portion of the lateral column. This structure forms a two-part vacuity. A dashed line 205 in FIG. 11 depicts a medial boundary of a first part 206 that is positioned to underlie the second, third and fourth metatarsals. A dashed line 207 extending from the medial edges of the insole base 201 defines a second part 208 of the vacuity that underlies the arch.

The insole base 201 typically is made of foam such as ethyl-vinyl-acetate or polyurethane. Material properties of the foam may be sport specific. For example, softer and elastic foam may be selected for running, harder and viscous foam for cycling or soft and viscous foam for golf. In this particular implementation these activities are used to select either a “dynamic” or a “static” footbed insole base 201. That is, a consumer selection of walking, running or golf causes the system to select a dynamic insole base while the selection of cycling, skating and skiing causes the system to select a static insole base. Other combinations are also possible.

FIGS. 11 and 12 depict a metatarsal pad insert 210 that includes a foam pad 211 affixed an attachment layer 212. The foam pad 211 is formed with a periphery to correspond to part 206 of the vacuity. That is, the foam pad 211 fills the vacuity part 206 when the underlying layer 212, that includes hook and loop portions as an example, attaches to corresponding hook and loop surfaces on the bottom of the insole base 201.

The final component is an arch support insert 220 shown in each of FIGS. 11 through 14. The arch support 220 has a curved upper portion 221 and an essentially flat lower portion 222 that are joined at the ends. The curved upper portion is flexible in three dimensions and is typically made of a plastic, such as polyether block amide sold under the trademark Pebax® owned by Arkema, a French corporation or a thermoplastic urethane. Curved upper portion 221 forms an arch to accommodate the human medial arch. As the upper portion is flexible in three dimensions, it can adjust to height, length and shape of the foot arch. The lower part 222 is essentially flat and stiff. It includes portions 223 and 224 containing hook and loop material that attaches to corresponding material on the underside of the insole base 201. A layer 225 of soft foam overlies the upper portion 221 to provide physical comfort.

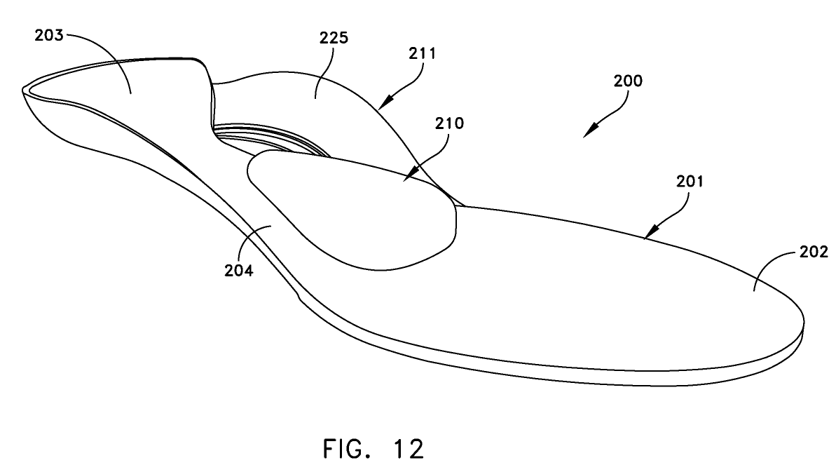

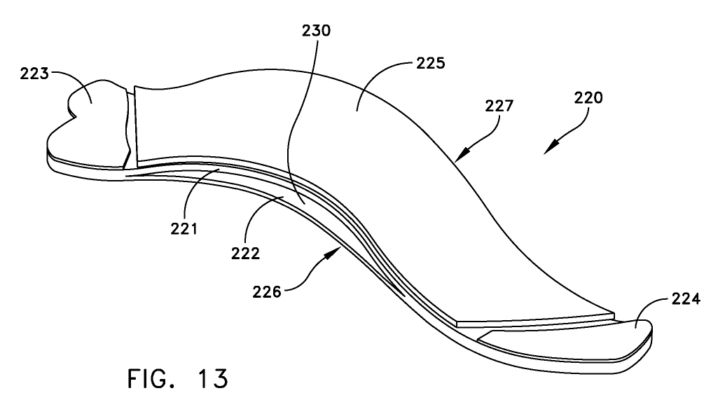

Referring specifically to FIGS. 13 and 14, a finished arch support insert 220 has a medial edge 226 and a lateral edge 227. FIG. 13 is a perspective view from the medial edge 226; FIG. 14, from the lateral edge 227. The curved support portion 221 and layer 225, attached at the ends thereof to the lower part 222, cant from a minimum separation from the lower part 222 at the medial edge 226 to a maximum at the lateral edge 227. This cant facilitates the fit between the consumer's arch and the layer 225. The lower part 222 further prevents the upper part 221 from flattening during use.

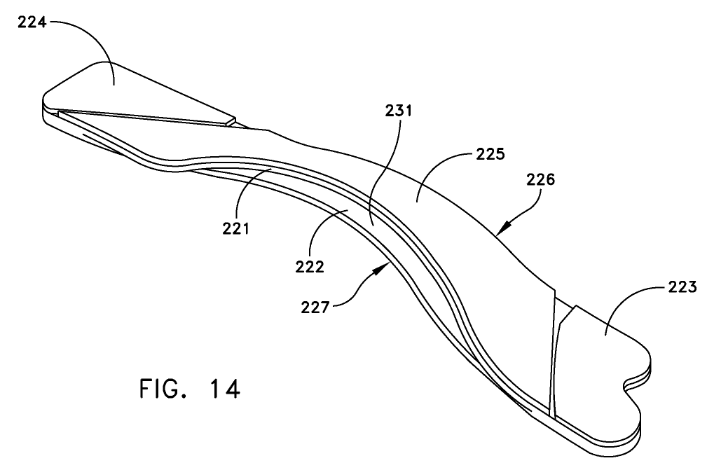

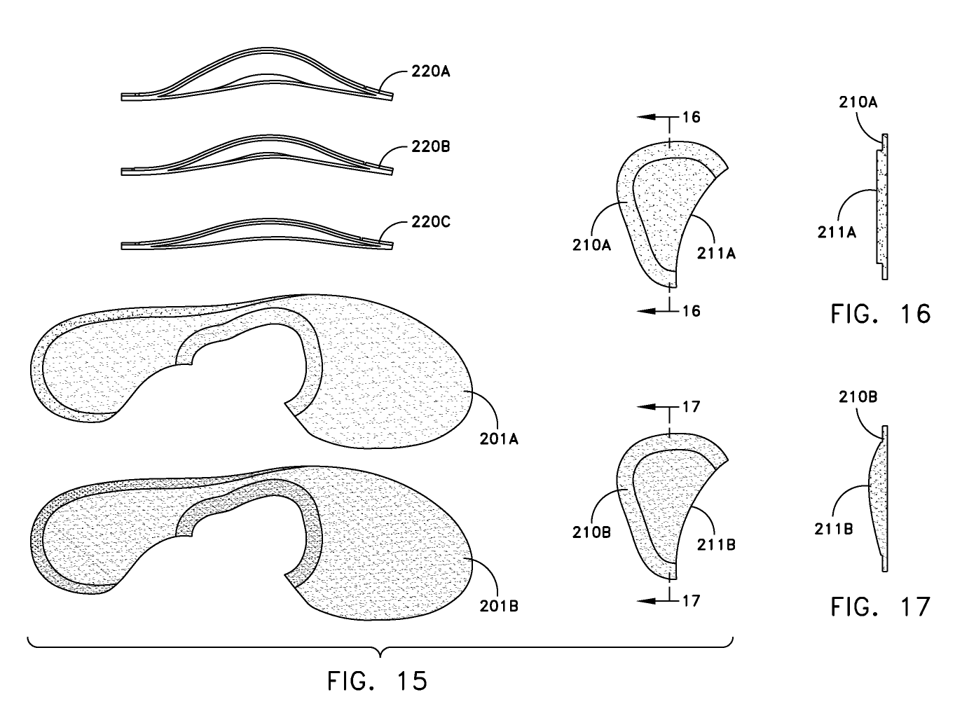

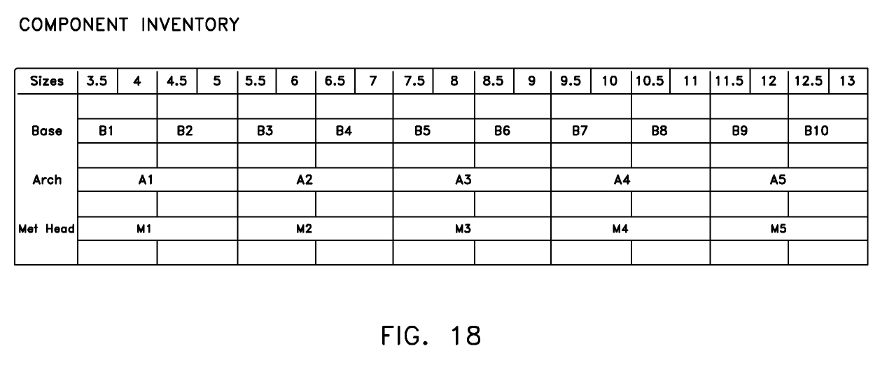

FIG. 15 is useful in understanding a range of variations that can be achieved by combining the component shown in FIGS. 11 and 12. Specifically, FIG. 15 depicts two insole bases 201A and 201B in a group of the same size. For example, the insole base 201A is in a subgroup constructed for static use; the insole base 201B, in a subgroup for dynamic use. Two metatarsal pad inserts 210A and 210B are in a group for a given insole base size that includes at least two subgroups. As shown in FIGS. 15 and 16, the metatarsal pad insert 210A has a relatively flat foam pad 211A and is in a first subgroup; the metatarsal pad insert 210B, as shown in FIGS. 15 and 17, has a rounded and thicker foam pad 211B and is in the second subgroup. The shapes of the metatarsal pad inserts for each subgroup are shown in FIG. 15. FIG. 15 also depicts a group of arch support inserts 220A, 220B and 220C that provide support for high, medium and low arches subgroups, respectively.

With this range of components, it will be apparent that the materials of the insole base 201 in FIG. 12 can be varied for different applications. The metatarsal pad insert 210 can be modified to provide different support functions. The arch support insert 220 can be selected to provide different elevations for arch support. In this specific example, a combination of a component from selected subgroups enables a given footbed to have one of twelve variations.

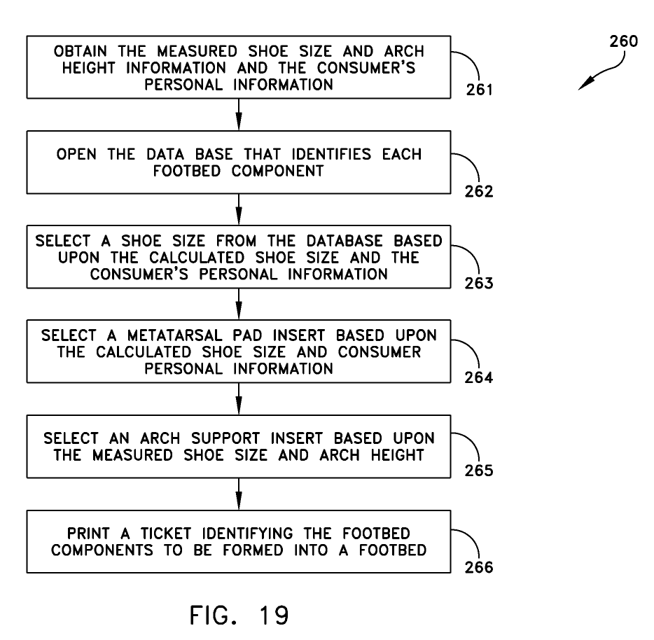

As previously indicated, the system of this invention assumes that at each kiosk location there will be a matrix of components such as shown in FIG. 14 that can be assembled into any of the wide variety of footbeds for shoes. As shown in FIG. 18, in one particular embodiment, the inventory covers shoe sizes from 3.5 to 13. It has been found by analyzing thousands of images obtained by means of the apparatus and procedure shown U.S. Pat. App. Pub. No. US2006/0283243, that one group of insole bases 201 can be sized to accommodate two shoe half sizes. Consequently, the inventory only requires ten pairs of insole bases lengths for a range of twenty half-shoe sizes. This number will be multiplied further by the different types of materials used in the insole bases 201; for example, twenty pairs of insole bases if there are static and dynamic footbeds. Likewise, using the system of FIG. 18 as the model, it has been found that each group of arch support inserts 220 and each group of metatarsal pads 210 will span four half sizes. That is, there is a requirement of a total of ten pairs of metatarsal pads if two thicknesses are available. There will be a total of fifteen pairs of arch support inserts assuming that there are three arch heights.

With this understanding of the matrix of components that may be available for a footbed, it will now be helpful to describe a process by which all the data is converted into a list of footbed components. FIG. 19 depicts one process 250 that beings at step 251 by obtaining the measured shoe size and arch height information developed by the process in FIG. 10 and the personal information as entered on the screen of FIG. 9B. Step 252 establishes a session with a local database that contains the information about each different footbed component in inventory at the location.

Step 253 uses the measured shoe size and the consumer's personal information to select specific left and right foot insole bases. For example, if the measured shoe size for the consumer's left foot is size 9 and the selected activity requires a dynamic insole base, step 253 selects a specific insole base having the specified size and the appropriate construction.

Step 254 performs a similar function. That is, the consumer's personal information and shoe size are used to identify a metatarsal pad insert of the appropriate size and the appropriate thickness.

Step 255 uses the measured shoe size and arch height to select a specific arch support insert. That is, a high, medium or low arch support insert will be identified for the selected insole base.

Step 256 uses this information to produce a ticket, for example, at a printer such as the printer 54 in FIGS. 4 and 7. The ticket lists the left and right foot insole bases, the left and right foot metatarsal inserts and the left and right foot arch support inserts. With this information, the consumer can easily retrieve and assemble the components from the local inventory to into the two footbeds.

### Network

The foregoing discussion of processing is related to an independent, stand alone kiosk. FIGS. 1 and 2 depict a network of measurement stations at different locations. Each measurement station 21, 22 and 23 connects to a central site 250 through standard communications paths. At the central site 250 includes a data processing system 251 accumulates data from each of the measurement stations for purposes of further analysis, particularly for ascertaining improvements that can be made in the processes for selecting components. In addition, the central site 250 can include manufacturing tooling 252 for manufacturing footbeds using the measurements garnered from a measurement site as input to a process such as shown in the previously identified U.S. Pat. App. Pub. No. 2006/0283243.

The process 35 in FIG. 2, may also transfer information for storage at 254 at the central site 250. It can also establish a queue whereby the manufacturing tooling 252 uses the data to manufacture a custom footbed as shown in step 255 based upon a selection at the screen of FIG. 9L.

In summary, there has been disclosed one implementation of a “self serve” footbed system for providing a consumer with footbeds that match his or her needs. This system includes a consumer-operated provides a measurement system, such as included in the kiosk as shown in FIGS. 3 through 7 or any equivalent thereof. A kiosk includes a data processor that operates generally along the lines as shown in FIG. 8 with prompts as shown in FIGS. 9A through 9L guiding the consumer through the measurement phase. The central processor additionally controls scanning and converts the resulting information into shoe size and arch length to yield, with other personal information gathered from the kiosk about the individual's end use for the footbed, a list of components to be used to produce footbeds tailored to the consumer's needs. The consumer then uses this list to retrieve the various components from a prestock inventory such as that shown in FIG. 14 for assembly in association with FIGS. 11 and 12.

### Alternatives

Such a system may perform various tests to determine at a basic level whether this system can provide satisfactory footbeds. For example, if the measurement phase determines that the required arch height exceeds the maximum height of any arch support insert, it is highly likely that the process will not produce a satisfactory footbed. Excessive rotation of the pressure image to achieve appropriate foot alignment may indicate excessive tibial torsion that could affect the validity of the measurements. If these of other tests fail, the system should display a message to the consumer terminating the process and recommending the consumer consult with a professional.

As previously indicated and referring to FIG. 3, the pressure mat 45 and related equipment record the data for forming the foot image on a dynamic basis. This permits alternate procedures for capturing the information needed for the foot image. In one variation, the consumer merely runs or walks across the pressure mat 45 while attached to the base 41 striking the pressure mat 45 once with each foot. In another variation the base extension 44 and pressure mat 45 are detached from the base 41 while maintaining electrical continuity. Now the consumer can run across the pressure mat 45 in any direction. As yet another variation, the pressure mat 45 could be separate and elongated whereby the consumer produces readings while running or walking along the length of the pressure pad.

This invention has been described in terms of a specific implementation with reference to specific variations. It will be obvious to those of ordinary skill in the art that myriad variations and modifications could be made to this specifically disclosed implementation without departing from the spirit and scope of this invention. Therefore, it is the intent of the appended claims to cover all such variations and modifications as come within the true spirit and scope of this invention.

What is claimed as new and desired to be secured by Letters Patent of the United States is:

1. A method for obtaining measurements for use in the construction of a footbed for a consumer comprising:
A) generating foot images of each of the consumer's feet, and
B) for each foot:
i) projecting the corresponding foot image at a measurement position,
ii) capturing the foot at the measurement position in a position essentially aligned with the projected foot image,
iii) obtaining an array of measurements representing the topography of the individual's foot, and
iv) converting the array of measurements to information for producing a footbed for the individual's foot.

2. A method as recited in claim 1 wherein said foot image generation includes the steps of:
i) stepping on a pressure sensitive mat that produces an array of pressure signals,
ii) recording the array of pressure signals, and
iii) processing the array of pressure signals to obtain an image of each foot.

3. A method as recited in claim 2 wherein foot image generation includes the step of rotating each image to a reference position.

4. A method as recited in claim 1 wherein said capturing includes:
i) placing a foot on a means for measuring the topography of the plantar surface of the foot at a position defined by the projected foot image, and
ii) adjusting said measuring means to engage the plantar surface of the foot and contain the tissue thereat thereby to position the foot in a semi-weighted supported position.

5. A method as recited in claim 4 wherein said foot topography measuring means includes a base plate and a flexible membrane attached thereto that forms an adjustable cushion and said adjustment includes varying the pressure in said adjustable cushion to displace the foot from said base plate prior to said step of obtaining measurements.

6. A method as recited in claim 5 additional including monitoring the elevation of the foot above the base plate thereby to enable said step of obtaining measurements when the capturing means positions the foot in a semi-weighted supported position.

7. A method as recited in claim 1 wherein said array of measurements are obtained by scanning the bottom of the foot with the array of measurements representing the distance of different portions of the plantar surface from a reference plane.

8. A method as recited in claim 7 wherein said scanning projects light onto the plantar surface that reflects therefrom and collecting said reflect light.

9. A method as recited in claim 1 wherein said conversion includes:
i) storing the array of measurements, and
ii) processing the array of measurements to obtain information about the consumer's foot size and arch height.

10. A method as recited in claim 9 wherein a footbed is formed of a plurality of footbed components, said conversion further including the step of identifying components for forming a footbed in response to the foot size and arch height information.

11. A method as recited in claim 9 wherein the consumer provides personal information and wherein a footbed is formed of a plurality of footbed components, said conversion further including the step of identifying components for forming a footbed in response to the foot size, arch height and personal information.

12. A method as recited in claim 9 wherein one of the identified components is an insole base taken from a group of insole bases and said conversion identifies the insole base in response to foot size and personal information.

13. A method as recited in claim 9 wherein one of the identified components is an arch insert taken from a group of arch inserts and said conversion identifies said one arch insert in response to foot size, arch height and personal information.

14. A method as recited in claim 9 wherein one of the identified components is a metatarsal pad insert taken from a group of metatarsal pad inserts and said conversion identifies the metatarsal pad insert in response to the foot size and personal information.

15. A method as recited in claim 1 wherein said method is practiced at a plurality of geographical sites, said method including storing the information obtained during said conversion from each geographical site at a central site.

16. Apparatus for providing information for the production of an inner sole for a consumer's footwear comprising:
A) means for generating an image of the consumer's feet,
B) a frame,
C) foot capture means mounted to said frame for positioning a foot,
D) means on said frame for displaying the generated image of the individual's foot onto said foot capture means thereby to assist in the correct positioning of the individual's foot, and
E) means for generating a representation of the topography of the individual's foot when on said foot capture means, said representation being used in the production of the inner sole.

17. Apparatus as recited in claim 16 wherein said foot image display means includes:
i) pressure sensitive mat means for producing an array of pressure signals when a consumer steps thereon,
ii) means for recording the array of pressure signals, and
iii) means for processing the array of pressure signals to obtain an image of each foot.

18. Apparatus as recited in claim 17 wherein foot image display means includes means for rotating each image to a reference position.

19. Apparatus as recited in claim 16 wherein said foot capture means includes:
i) means for measuring the topography of the plantar surface when the foot is at a position defined by the displayed foot image, and
ii) means for adjusting said measuring means to engage the plantar surface of the foot and contain the tissue thereat thereby to position the foot in a semi-weighted supported position.

20. Apparatus as recited in claim 19 wherein said foot topography measuring means includes a base plate and a flexible membrane attached thereto that forms an adjustable cushion and said adjustment means includes means for varying the pressure in said adjustable cushion to displace the foot from said base plate prior to generating the representation of the foot's topography.

21. Apparatus as recited in claim 20 additionally including means for monitoring the elevation of the foot above the base plate thereby to enable said capture means to position the foot in a semi-weighted supported position.

22. Apparatus as recited in claim 16 wherein said generation means includes means for scanning the bottom of the foot to produce an array of measurements representing the distance of different portions of the plantar surface from a reference plane.

23. Apparatus as recited in claim 22 wherein said scanning means includes means for projecting light onto the plantar surface that reflects therefrom and means for collecting said reflected light.

24. Apparatus as recited in claim 16 wherein said conversion means includes:
i) means for storing the array of measurements, and
ii) means for processing the array of measurements to obtain information about the consumer's foot size and arch height.

25. Apparatus as recited in claim 24 wherein a footbed is formed of a plurality of footbed components, said conversion means including means for identifying components for forming a footbed in response to the foot size and arch height information.

26. Apparatus as recited in claim 24 wherein the consumer provides personal information and wherein a footbed is formed of a plurality of footbed components, said conversion means including means for identifying components for forming a footbed in response to the foot size, arch height and personal information.

27. Apparatus as recited in claim 24 wherein one of the identified components is an insole base taken from a group of insole bases and said conversion means identifies the insole base in response to foot size and personal information.

28. Apparatus as recited in claim 24 wherein one of the identified components is an arch insert taken from a group of arch inserts and said conversion means identifies the arch insert in response to foot size, arch height and personal information.

29. Apparatus as recited in claim 24 wherein one of the identified components is a metatarsal pad insert taken from a group of metatarsal pad inserts and said conversion means identifies the metatarsal pad insert in response to the foot size and personal information.

30. Apparatus as recited in claim 16 including apparatus at each of a plurality of geographical sites, said apparatus including means at a central site for storing information obtained from said conversion means at each geographical site.

31. A footbed for an individual's foot characterized by forefoot, rearfoot, lateral and medial column, arch and metatarsal head areas, said footbed comprising:
A) an insole base taken from a group of insole bases for underlying the forefoot and rearfoot areas and portions of the lateral column area between the forefoot and rearfoot areas, said insole base having a vacuity substantially coextensive with the areas underlying the arch and metatarsal head areas and portions of the medial column area,
B) a metatarsal pad insert taken from a group of metatarsal pad inserts of different properties,
C) an arch support insert taken from a group of arch support inserts of different properties, and
D) means for attaching said metatarsal pad and arch support inserts to said base member to span said vacuity for providing support for the metatarsal head and arch areas of the foot, respectively.

32. A footbed as recited in claim 31 wherein said insole base is taken from a group of insole bases having an overall length and a vacuity area that vary according to shoe size.

33. A footbed as recited in claim 32 wherein a single one of said insole bases corresponds to a plurality of shoe sizes.

34. A footbed as recited in claim 33 wherein said plurality is at least two half shoe sizes.

35. A footbed as recited in claim 32 wherein insole bases in said group of insole bases have different stiffness characteristics.

36. A footbed as recited in claim 32 wherein the configuration of metatarsal pad inserts in said group of metatarsal pad inserts vary according to shoe size and pad height.

37. A footbed as recited in claim 36 wherein a single one of said metatarsal pad inserts corresponds to a plurality of shoe sizes.

38. A footbed as recited in claim 37 wherein said plurality is up to four half shoe sizes.

39. A footbed as recited in claim 32 wherein the configurations of arch support inserts in said group of arch support inserts vary according to shoe size and arch height.

40. A footbed as recited in claim 39 wherein a single one of said arch support pad inserts corresponds to a plurality of shoe sizes.

41. A footbed as recited in claim 40 wherein said plurality is up to four half shoe sizes.

42. A footbed as recited in claim 31 wherein said attachment means includes hook and loop material attached to the underside of said insole base adjacent said vacuity and to the periphery of said metatarsal pad insert and the ends of said arch support insert.

43. A footbed as recited in claim 31 wherein said attachment means includes complementary hook and loop strips, one of said hook and loop strips being attached to the underside of said insole member adjacent said vacuity and the other of said hook and loop strips being attached to each of said metatarsal pad and arch support inserts.

44. A footbed as recited in claim 31 wherein each of said insole bases in said group of insole bases includes subgroupings according insole base stiffness.

45. A footbed as recited in claim 31 wherein each of said metatarsal pad inserts in said group of metatarsal pad inserts includes subgroupings according to pad height.

46. A footbed as recited in claim 45 wherein each of said metatarsal pad inserts includes a base layer and a pad attached thereto, said base layer including an element of said attachment means.

47. A footbed as recited in claim 31 wherein each of said arch support inserts in said group of arch support inserts includes subgroupings according to arch height.

48. A footbed as recited in claim 47 wherein each of arch support inserts includes:
i) a curved flexible upper portion that forms an arch for accommodating the individual's medial arch,
ii) a flat stiff lower portion attached to the ends of said upper portion thereby to stabilize said upper portion, said lower portion being attached to ends of said upper portion and extending beyond the end of said upper portion, and
iii) said portions of said lower portion extending beyond said upper portion including an element of said attachment means.

49. A footbed as recited in claim 31 wherein said a portion of the vacuity is coextensive with the position of the 2nd, 3re and 4th metatarsals.

50. A method for enabling a consumer at a store to obtain a footbed with characteristics that are adapted for the consumer's feet, said method comprising the steps of:
A) establishing an inventory of footbed components organized into a plurality of groups, each with at least one subgroup, the components in each subgroup and having certain characteristics,
B) providing a measurement system that guides the consumer through the steps of:
i) entering personal information into the system,
ii) generating a pressure map of the consumer's feet,
iii) generating a topographical map for each of the consumer's feet, and
iv) generating a list of one component from each subgroup for each foot, and
C) gathering from the inventory each component on the list for assembly by the consumer into footbeds for the consumer's feet.
